(19) United States
(12) Patent Application Publication
(10) Pub. No.: US 2021/0147068 A1
(43) Pub. Date: May 20, 2021

(54) DRONE CONTROL DEVICE USING MODEL PREDICTION CONTROL

(71) Applicant: PABLO AIR Co., Ltd., Incheon (KR)

(72) Inventor: Gyung Eon JEON, Incheon (KR)

(21) Appl. No.: 16/905,605

(22) Filed: Jun. 18, 2020

(30) Foreign Application Priority Data
Nov. 19, 2019 (KR) 10-2019-0148942

(51) Int. Cl. B64C 17/06; B64C 39/02; B64D 27/24; B64D 31/02; G05D 1/10

(52) U.S. Cl. CPC B64C 17/06; B64C 39/024; B64D 27/24; B64C 2201/14; G05D 1/101; B64C 2201/042; B64C 2201/108; B64D 31/02

(57) ABSTRACT

Provided is a device for controlling flight of a drone, the device including: a rotor on which a motor is mounted; and an inertial navigation control unit that controls a rotation speed of the motor mounted on the rotor, in which in order for a drone to perform a hovering operation, the inertial navigation unit computes the rotation speed of the motor using an x-axis inertia moment, a y-axis inertia moment, and a z-axis inertia moment, which are computed using equations, and a propeller rotation inertia moment (Jᵣ) that is an intrinsic constant for the drone, the equation being:

$${I}_{xx} = {I}_{yy} = \frac{2 {mr}^{2}}{5} + 2 {l}^{2} {m}_{r}$$

$${I}_{zz} = \frac{2 {mr}^{2}}{5} + 4 {l}^{2} {m}_{r} ,$$

where Iₓₓ=x-axis inertia moment, I_{yy}=y-axis moment, I_{zz}=z-axis inertia moment, l denotes a distance from the center axis of the drone to the motor, m denotes a weight of the drone, r denotes a radius of the drone, and mᵣ is a weight of one rotor.

### CROSS REFERENCE TO RELATED APPLICATION

The present application claims priority to Korean Patent Application No. 10-2019-0148942, filed on Nov. 19, 2019, the entire contents of which is incorporated herein for all purposes by this reference.

### BACKGROUND OF THE INVENTION

### Field of the Invention

The present invention relates to a drone control device using a model prediction control technique and, more particularly, to a drone control device capable of improving the stability of a drone during motion thereof by using a model prediction control technique.

### Description of the Related Art

Thanks to full-scale commercialization of super-precision subminiature sensors based on micro-electro mechanical systems (MEMSs) in sensing technology that is most fundamental to an unmanned mobile industry involving unmanned vehicles, unmanned aerial vehicles, unmanned robots, and the like, applications and potential markets of the unmanned mobile industry have dramatically increased. In order for an unmanned mobile apparatus to perform its assigned job, it is required that a position of the unmanned mobile apparatus is precisely measured.

In the case of low-priced position estimation systems that are currently available in the commercial markets, normal position estimation is possible in a limited environment, but measurement position information is disturbed in an area where GPS signals are weak. Algorithms for solving this problem have not yet been developed. Many related companies have made efforts to secure such algorithms.

FIG. 1 is a diagram illustrating a general position estimation system. An unmanned mobile apparatus 1, such as an unmanned aerial vehicle includes a sensing unit 10 and a control unit 20. The sensing unit 10 includes a GPS sensor 11 that determines a position of the unmanned mobile apparatus 1, an inertial sensor 12 that measures acceleration, and a geomagnetic sensor 13 that measures the intensity and direction of the earth's magnetic field. On the basis of information measured by the sensing unit 10, the control unit 20 performs control in such a manner that the unmanned mobile apparatus 1 operates.

However, a problem with the position estimation system in the related art is that errors due to drift are continuously accumulated as time goes by and thus an error occurs in a finally-computed position and positioning navigation information.

To solve this problem, instead of being used independently, the inertial navigation system is used together with one of various navigation systems that have been proposed to correct the navigation information in which the error occurs, and generally with a global navigation satellite system (GNSS).

However, a receiver that receives signals transmitted from GNSS navigation satellites may be greatly influenced by obstacles in the vicinity and radio disturbances. Particularly, in a case where the receiver operates at a low altitude in a downtown area where many buildings are tightly packed together or a remote mountain village, there occurs a problem in that navigation performance decreases.

Examples of the related art include Korean Patent Application Publication No. 2019-0092789 titled “METHOD OF MEASURING POSITION OF DRONE AND SYSTEM FOR CORRECTING POSITION OF POSITION USING SAME” and Korean Patent Application Publication No. 2019-0012439 titled “DEVICE AND METHOD FOR CORRECTING POSITIONAL INFORMATION OF DRONE”

### SUMMARY OF THE INVENTION

An objective of the present invention is to provide a method of controlling an output of a motor of a drone and thus improving the stability of the drone during motion thereof.

Another objective of the present invention is to provide a method of computing a rotation speed of a motor that constitutes a drone that performs a hovering operation.

According to an aspect of the present invention, there is provided a device for controlling flight of a drone, the device including: a rotor on which a motor is mounted; and an inertial navigation control unit that controls a rotation speed of the motor that is mounted on the rotor, in which, in order for a drone to perform a hovering operation, the inertial navigation unit computes the rotation speed of the motor using an x-axis inertia moment, a y-axis inertia moment, and a z-axis inertia moment, which are computed using the following equations, and a propeller rotation inertia moment (Jᵣ) that is an intrinsic constant for the drone.

$${I}_{xx} = {I}_{yy} = \frac{2 {mr}^{2}}{5} + 2 {l}^{2} {m}_{r} and$$

$${I}_{zz} = \frac{2 {mr}^{2}}{5} + 4 {l}^{2} {m}_{r} ,$$

where Iₓₓ=x-axis inertia moment, I_{yy}=y-axis moment, I_{zz}=z-axis inertia moment, l denotes a distance from the center axis of the drone to the motor, m denotes a weight of the drone, r denotes a radius of the drone, and mᵣ is a weight of one rotor.

The device for controlling flight of a drone according to the present invention computes the rotation speed of the motor that constitutes the drone that performs the hovering operation, and performs model prediction control, thereby efficiently controlling the drone.

In addition, according to the present invention, due to a characteristic of the model prediction control, a motion of the drone for a specific time is predicted (predicted on the basis of an equation of state for the drone) in advance, and control is performed in such a manner that the drone flies to a target destination in amounts of time and motion.

### BRIEF DESCRIPTION OF THE DRAWINGS

FIG. 1 is a diagram illustrating a general position estimation system;

FIG. 2 is a diagram illustrating a configuration of a device for estimating a position of a drone according to an embodiment of the present invention; and

FIG. 3 is a diagram illustrating positional information and rotational information of a drone that flies by rotation of a motor that constitutes a drone according to the present invention.

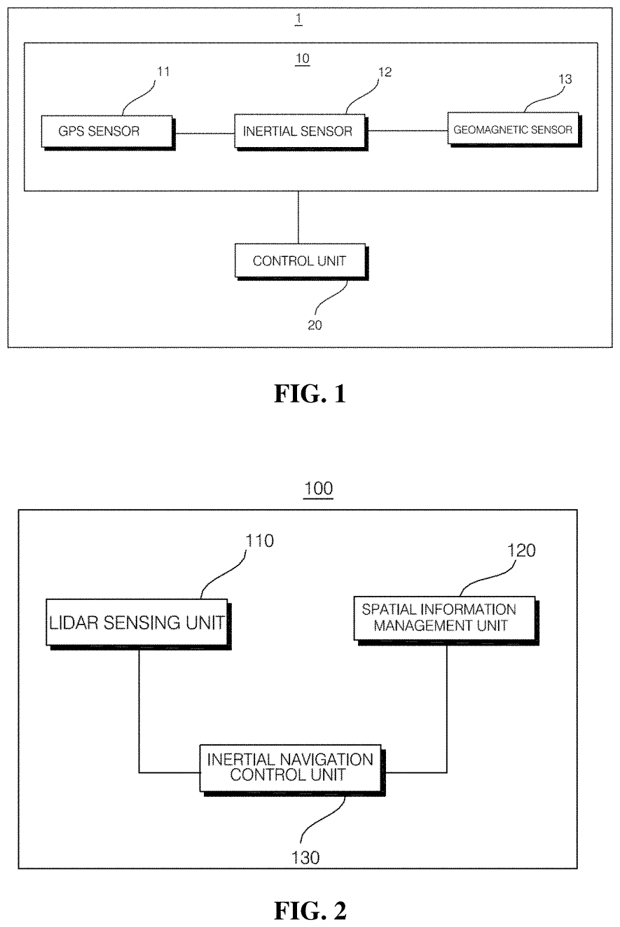

### DETAILED DESCRIPTION OF THE INVENTION

The above-described aspects of the present invention and additional aspects thereof will be apparent from a preferable embodiment that will be described with reference to the accompanying drawings. Descriptions will be provided below so in sufficient detail that a person of ordinary skill in the art clearly can understand and implement the embodiment of the present invention.

Model prediction control is a way of control, a system model for which is based on an optimization technique. The model prediction control is a way of control that predicts operational information and state information at a later specific time on the basis of current state information and thus determines an optimal control input using the optimization technique. For the optimization at this point, various pieces of information, such as minimization of vibration of the drone or a minimum time to a target destination, that are determined on the basis of state information of a drone are set in such a manner as to derive minimum and optimal values, and a motion of the drone and a rotation speed of a motor are set to satisfy constraint conditions. The utilization of this model prediction control technique makes it possible to more effectively control a drone control system that includes the drone.

FIG. 2 is a diagram illustrating a configuration of a device for estimating a position of a drone according to an embodiment of the present invention. The device for estimating a position of a drone according to the embodiment of the present invention will be described in detail below with reference to FIG. 2.

With reference to FIG. 2, a device 100 for estimating a position of a drone includes a lidar sensing unit 110, a spatial information management unit 120, and an inertial navigation control unit 130. Of course, a constituent element other than the constituent elements mentioned above may be included in the device for estimating a position of a drone according to the present invention.

The lidar sensing unit 110, installed in the drone, radiates a laser to geographic terrain in the vicinity, receives the laser reflected from the geographic terrain, and generates a measurement value profile. The drone measures a distance to an object that is present omnidirectionally in the horizontal direction.

That is, in a case where a measurement is taken to obtain a measurement value, the distance is omnidirectionally measured at a user-set interval with the drone in the center with respect to the horizontal axis. In addition, the lidar sensing unit 110 measures the distance in a range of +15° to −15° with respect to the vertical direction, and thus acquires a distance measure value that is a magnitude of m*n.

In addition, for the measurement value profile, it is also possible that the distance is acquired on the basis of transmission time and reception time for a laser, and the distance may be acquired by finding an intersection up to an obstacle in the vicinity with the lidar sensing unit 110 in the center.

The spatial information management unit 120 stores three-dimensional spatial information data including a coordinate value and an altitude value of the position of a building in the vicinity of an unmanned aerial vehicle.

In addition, two-dimensional spatial information is generated by extracting a positional coordinate value of a building from three-dimensional information provided through an open platform. The three-dimensional spatial information data stored in the spatial information management unit 120 is data that results from reflecting an altitude value into the generated two-dimensional spatial information on the building for conversion into three-dimensional spatial information.

The inertial navigation control unit 130 makes a comparison between the measurement value profile generated by the lidar sensing unit 110, and three-dimensional spatial information data for urban navigation in the spatial information management unit 120, and estimates a position of an unmanned aerial vehicle.

In addition, the inertial navigation control unit 130, which further includes a gyro sensor and an acceleration sensor, provides acceleration, a speed, a position, and positioning information, as pieces of navigation information, which are output from the gyro sensor and the acceleration sensor.

In addition, for the estimation of the position of the unmanned aerial vehicle, the inertial navigation control unit 130 may use an extended Kalman filter (EKF), a bank-of-Kalman filter (BKF), a point mass filter (PMF), or a particle filter (PF), or preferably, a PMF that is a nonlinear filter.

According to the present invention, a method is provided in which, due to a characteristic of model prediction control, a motion of gas for a specific time is predicted in advance and in which a target destination is reached in minimum amounts of time and motion. That is, a method is provided in which the motion of the drone is predicted in advance on the basis of an equation of state for the drone and in which the target destination is reached in the minimum amounts of time and motion on the basis of the predicted motion of the drone.

Particularly, according to the present invention, a method in which with an optimal hovering operation is performed by control of a rotation speed of a rotor (or motor) and a method in which robustness against external forces, such as winds, is increased.

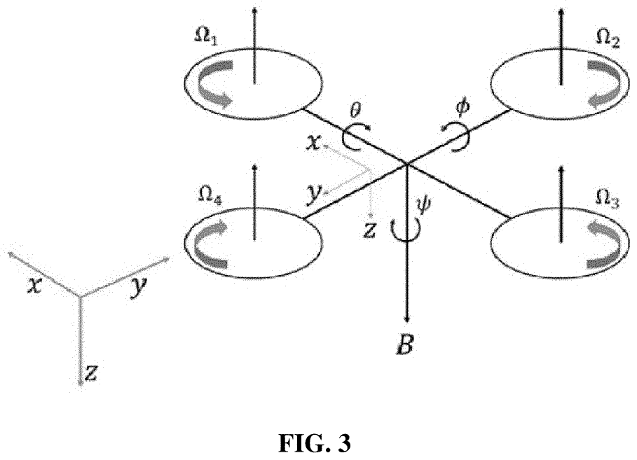

FIG. 3 is a diagram illustrating positional information and rotational information of the drone that flies by rotation of the motor that constitutes the drone according to the present invention. The positional information and rotational information of the drone that flies by the rotation of the motor that constitutes the drone according to the present invention will be described in detail below with reference to FIG. 3.

As illustrated in FIG. 3, the drone includes four rotors. The rotors rotate at speeds of S21, S22, S23, and S24 respectively. The center of the drone is positioned on (x, y, z) axes. The drone rotates at an angular velocity of Θ in the x-axis direction, at an angular velocity of ϕ in the y-axis direction, and at an angular velocity of Ψ in the z-axis direction. The inertial navigation control unit 130 computes the rotation speed of the motor that rotates the rotor, using the following equation, and drives the motor at the computed rotation speed.

A method will be described below in which, as described above, the drone positioned at a current point (x, y, z) moves in the minimum amounts of time and motion, which are represented by (x^{r}, y^{r}, z^{r}). Particularly, according to the present invention, a method is provided in which the hovering operation is performed in such a manner that a current position and a target position to which the drone will move are the same or that a difference therebetween is minimized. Of course, as described above, the hovering of the drone is realized by the rotation speed of the motor that rotates the rotor.

$$\ddot{φ} = \dot{Θ} \dot{ψ} {a}_{1} + \dot{θ} {a}_{2} {Ω}_{r} + {b}_{1} {U}_{2} \\ \ddot{Θ} = \dot{φ} \dot{ψ} {a}_{3} - \dot{φ} {a}_{4} {Ω}_{r} + {b}_{2} {U}_{3} \\ \ddot{ψ} = \dot{φ} \dot{Θ} {a}_{5} + {b}_{3} {U}_{4} \\ \ddot{x} = ( cos φ sin Θ cos ψ + sin φ sin ψ ) {U}_{1} \text{/} m \\ \ddot{y} = ( cos φ sih Θ sin ψ - sin φ cos ψ ) {U}_{1} \text{/} m \\ \ddot{z} = - g + ( cos φ cos Θ ) {U}_{1} \text{/} m \\ where [ \begin{matrix}{U}_{1} \\ {U}_{2} \\ {U}_{3} \\ {U}_{4} \\ {Ω}_{r}\end{matrix} ] = [ \begin{matrix}b ( {Ω}_{1}^{2} + {Ω}_{2}^{2} + {Ω}_{3}^{2} + {Ω}_{4}^{2} ) \\ b ( {Ω}_{2}^{2} - {Ω}_{4}^{2} ) \\ b ( - {Ω}_{1}^{2} + {Ω}_{3}^{2} ) \\ d ( - {Ω}_{1}^{2} + {Ω}_{2}^{2} - {Ω}_{3}^{2} + {Ω}_{4}^{2} ) \\ - {Ω}_{1} + {Ω}_{2} - {Ω}_{3} + {Ω}_{4}\end{matrix} ] \\ {a}_{1} = \frac{{I}_{yy} - {I}_{zz}}{{I}_{xx}} , {a}_{2} = \frac{{J}_{r}}{{I}_{xx}} , {a}_{3} = \frac{{I}_{zz} - {I}_{xx}}{{I}_{yy}} , \\ {a}_{4} = \frac{{J}_{r}}{{I}_{yy}} , {a}_{5} = \frac{{I}_{xx} - {I}_{yy}}{{I}_{zz}} , \\ {b}_{1} = \frac{l}{{I}_{xx}} , {b}_{2} = \frac{l}{{I}_{yy}} , {b}_{3} = \frac{l}{{I}_{zz}} \qquad Equation 1$$

Symbols that are used in Equation 1 are described in Table 1.

TABLE 1

| Symbol | Description | Unit |
|---|---|---|
| Θ | Euler angle pitch (with respect | deg |
| | to the x-axis) | |
| ϕ | Euler angle roll (with respect | deg |
| | to the y-axis) | |
| ψ | Euler angle roll (with respect | deg |
| | to the y-axis) | |
| x, y, z | Current position vector of for | m |
| | the drone | |
| Ωᵢ, i = 1, 2, 3,4 | Rotation speeds of motors | radius |
| | (motors 1, 2, 3, and 4) | |
| g | Gravitational | m/s² |
| | acceleration | |
| Iₓₓ | x-axis inertia moment (in the | Kg · m² |
| | body coordinate frame) | |
| I_{yy} | y-axis inertia moment (in the | Kg · m² |
| | body coordinate frame) | |
| I_{zz} | y-axis inertia moment (in the | Kg · m² |
| | body coordinate frame) | |
| Jᵣ | Propeller rotation | Kg · m² |
| | inertia moment | |
| | (Intrinsic constant for | |
| | the drone) | |
| l | Length from the | m |
| | central axis to the center of the | |
| | motor | |
| x^{r}, y^{r}, z^{r} | Target position vector | m |
| | (Target) | |
| b | Thrust coefficient | Ns/m |
| d | Drag coefficient | Nm · s |

In addition, the inertia moment is computed using the following equation.

$${I}_{xx} = {I}_{yy} = \frac{2 {mr}^{2}}{5} + 2 {l}^{2} {m}_{r} \\ {I}_{zz} = \frac{2 {mr}^{2}}{5} + 4 {l}^{2} {m}_{r} , \qquad Equation 2$$

where m denotes weight (unit: kg), r denotes a radius (unit: m) of the drone, and mᵣ denotes one weight (unit: kg), Iₓₓ=I_{yy} is determined on the assumption that a distance between rotors is fixed. Therefore, in a case where the drone has a different shape, the x-axis inertia moment and the y-axis inertia moment are different.

In addition, an equation of state may include a state variable and a control constant. The state variable is determined by a position of the drone and an angular velocity thereof. The control variable is determined by a rotation speed of the motor.

The state variable defines a motion (a change) of a dynamic system when the drone is designed as a mathematical model. The control variable is determined by a change in the state variable.

The state variable and the state information have the same meaning. However, the state variable is expressed as a specific symbol in a state equation, and the state information is expressed as a specific numerical value. The control variable, like the state variable, is also expressed as a symbol and indicates control according to the state equation, and the control information is expressed as a specific numerical value and indicates the magnitude of control at the present time.

State variable: the position of the drone, the angular velocity thereof→x=[ϕ \dot{ϕ} θ \dot{θ} Ψ \dot{Ψ} x \dot{x} y \dot{y} z ż]^{T}

Control variable: the rotation speed of the motor→u=[Ω₁ Ω₂ Ω₃ Ω₄]^{T}

(x^{r}, y^{r}, z^{r}) is determined by a cost function (a function that determines an optimal value) for optimization.

Generally, the cost function for optimization is expressed using the following Equation 3.

$$J = {min}_{Δ U} {\sum }_{k = 0}^{N - 1} {( y ( k + 1 ) - {y}^{r} ( k ) )}^{T} Q ( y ( k + 1 ) - {y}^{r} ( k ) ) + {( u ( k ) - u ( k - 1 ) )}^{T} R ( u ( k ) - u ( k - 1 ) ) , \qquad Equation 3$$

where Q denotes a weighting factor for the state information, and R denotes a weighting factor for the control information. Magnitudes of the weighting factors are determined according to a value that is desired to be minimized, and are in the form of a square symmetric matrix.

\dot{x}=Ax+Bu

y=Cx

where y denotes a result value from the equation of state for the drone. Because y includes a current position (x, y, z) of the drove and y^{r} is expressed as (x^{r}, y^{r}, z^{r}), when the current position is the same as the target position or a difference therebetween is minimized, the smallest minimum value is obtained. Therefore, it is possible that the drone is controlled in such a manner as to move in the amounts of time and motion.

In addition, the state variable and the control variable may be set in such a manner as to vary within a range that is set.

xₘᵢₙ≤x(k)≤xₘₐₓ,0≤u(k)≤uₘₐₓ

In addition, the rotation speed of the motor may also be set in such a manner to vary within a range that is set.

0≤Ωᵢ≤Ωᵢ^{max},i=1,2,3,4

The embodiment of the present invention is described only in an exemplary manner referring to the drawings. It will be apparent to a person of ordinary skill in the art to which the present invention pertains that various other modifications and equivalents are possible from this description.

What is claimed is:

1. A device for controlling flight of a drone, the device comprising:
a rotor on which a motor is mounted; and
an inertial navigation control unit that controls a rotation speed of the motor that is mounted on the rotor,
wherein, in order for a drone to perform a hovering operation, the inertial navigation unit computes the rotation speed of the motor using an x-axis inertia moment, a y-axis inertia moment, and a z-axis inertia moment, which are computed using equations, and a propeller rotation inertia moment (Jᵣ) that is an intrinsic constant for the drone, the equation being:
$${I}_{xx} = {I}_{yy} = \frac{2 {mr}^{2}}{5} + 2 {l}^{2} {m}_{r} and$$
$${I}_{zz} = \frac{2 {mr}^{2}}{5} + 4 {l}^{2} {m}_{r} ,$$
where Iₓₓ=x-axis inertia moment, I_{yy}=y-axis moment, I_{zz}=z-axis inertia moment, l denotes a distance from the center axis of the drone to the motor, m denotes a weight of the drone, r denotes a radius of the drone, and mᵣ is a weight of one rotor.

2. The device according to claim 1, wherein the inertial navigation control unit computes the rotation speed of the motor using the following equation that is an equation of state:
$$\ddot{φ} = \dot{Θ} \dot{ψ} {a}_{1} + \dot{θ} {a}_{2} {Ω}_{r} + {b}_{1} {U}_{2}$$
$$\ddot{Θ} = \dot{φ} \dot{ψ} {a}_{3} - \dot{φ} {a}_{4} {Ω}_{r} + {b}_{2} {U}_{3}$$
$$\ddot{ψ} = \dot{φ} \dot{Θ} {a}_{5} + {b}_{3} {U}_{4}$$
$$\ddot{x} = ( cos φ sin Θ cos ψ + sin φ sin ψ ) {U}_{1} \text{/} m$$
$$\ddot{y} = ( cos φ sih Θ sin ψ - sin φ cos ψ ) {U}_{1} \text{/} m$$
$$\ddot{z} = - g + ( cos φ cos Θ ) {U}_{1} \text{/} m$$
$$where [ \begin{matrix}{U}_{1} \\ {U}_{2} \\ {U}_{3} \\ {U}_{4} \\ {Ω}_{r}\end{matrix} ] = [ \begin{matrix}b ( {Ω}_{1}^{2} + {Ω}_{2}^{2} + {Ω}_{3}^{2} + {Ω}_{4}^{2} ) \\ b ( {Ω}_{2}^{2} - {Ω}_{4}^{2} ) \\ b ( - {Ω}_{1}^{2} + {Ω}_{3}^{2} ) \\ d ( - {Ω}_{1}^{2} + {Ω}_{2}^{2} - {Ω}_{3}^{2} + {Ω}_{4}^{2} ) \\ - {Ω}_{1} + {Ω}_{2} - {Ω}_{3} + {Ω}_{4}\end{matrix} ] and$$
$${a}_{1} = \frac{{I}_{yy} - {I}_{zz}}{{I}_{xx}} , {a}_{2} = \frac{{J}_{r}}{{I}_{xx}} , {a}_{3} = \frac{{I}_{zz} - {I}_{xx}}{{I}_{yy}} , \\ {a}_{4} = \frac{{J}_{r}}{{I}_{yy}} , {a}_{5} = \frac{{I}_{xx} - {I}_{yy}}{{I}_{zz}} , \\ {b}_{1} = \frac{l}{{I}_{xx}} , {b}_{2} = \frac{l}{{I}_{yy}} , {b}_{3} = \frac{l}{{I}_{zz}} ,$$
where Ωᵢ denotes an i-th rotation speed (i=1, 2, 3, 4), θ denotes a Euler angle pitch (with respect to the x-axis), ϕ denotes an Euler angle roll (with respect to the y-axis), Ψ denotes an Euler angle yaw (with respect to the z-axis), g denotes gravitational acceleration, b denotes a thrust coefficient, and d denotes a drag coefficient.

3. The device according to claim 2, wherein the drone includes four motors and distances from the center of the drone to the rotors are the same.

4. The device according to claim 3, wherein a state variable in the equation of state is a position of the drone or an angular velocity thereof, and a control variable in the equation of state is the rotation speed of the motor.

5. The device according to claim 4, wherein each of the state variable and the control variable are set to have a value that falls within a range that is set.
